(19) United States
(12) Patent Application Publication
(10) Pub. No.: US 2022/0169158 A1
(43) Pub. Date: Jun. 2, 2022

(54) RESISTANCE HEAT ASSISTED COOLING AND HEATING TECHNOLOGY

(71) Applicant: GENTHERM INCORPORATED, Northville, MI (US)

(72) Inventor: Charles J. Cauchy, Traverse City, MI (US)

(21) Appl. No.: 17/433,893

(22) PCT Filed: Feb. 27, 2020
(86) PCT No.: PCT/US2020/020237

§ 371 Date: Aug. 25, 2021

Related U.S. Application Data
(60) Provisional application No. 62/812,614, filed on Mar. 1, 2019.

(51) Int. Cl. B60N 2/56; F25B 21/04

(52) U.S. Cl. CPC B60N 2/5685; F25B 2321/023; F25B 21/04

(57) ABSTRACT

Various aspects of a rapid effect heat resistant heat and cool assist device is disclosed for providing quick heat and cool comfort to a person, including at least one heat resistant thermal conductor covering a surface area of a heat and cool device for thermal communication to comfort a person, wherein the heat resistant thermal conductor is preferably made of graphene, and has a time to-sensation time period of from 5 seconds to 10 min. and is capable of reaching temperatures from 5° C. to 60° C. for providing heat and cool comfort to a person.

### CROSS-REFERENCE TO RELATED APPLICATIONS

This application claims the benefit under 35 U.S.C. 119(e) of U.S. Provisional Application No.: 62/812,614 filed on Mar. 1, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates to thermoelectric heating systems, methods of manufacturing same, and methods of using same. More particularly, the invention relates to resistance heat assisted cooling and heating technologies.

### 2. Description of the Prior Art

Conventional thermoelectric heating systems are well known in the art, including one of the most common types of thermoelectric heating systems that includes a thermoelectric module, a heat sink and a conductive member to distribute the heat.

However, practitioners of those inventions have become aware of certain problems in low temperature situations which are presented by those prior art inventions. One particular problem that has plagued users has been that in extreme weather conditions of cold, the systems heat up quite slowly, and users would prefer the heating system to heat up faster than they currently do. In the heating mode of the thermoelectric heating system, there are complexities which give rise to a low level of heat being pumped from a cold heat sink to the desired location in low temperature situations.

Some prior art applications have included the use of an added resistance heating mat spread across the surface to be heated. However, this is not a desirable solution to the problem because the heating mats provide resistance heat to the seat occupant, but in very cold temperatures, quick heating is desirable. In order to provide quicker heating in automotive applications, outdoor heavy equipment, sport vehicles and applications that are used in very cold temperatures, it would be desirable to have the thermoelectric device itself warm up quicker, so that it can pump heat to the seat occupant.

In most aspects disclosed in previously filed applications by the present inventor, the thermoelectric heating system is able to satisfy customer requirements for heating seat occupants using the technology outlined in the U.S. Ser. No. 15/526,954 application “Heating and Cooling Technologies.”, which is incorporated in its entirety herein. However, there are automotive OEM (Original Equipment Manufacturer) specifications that require the system to heat up more rapidly when at extremely low temperatures, for example, −25° C. The system as now designed does meet all OEM's specifications for speed to reach certain set temperatures.

In the heating mode, the thermoelectric device takes heat from the heat sink and pumps it to the occupant side of the system. Resistance heating also occurs in the TE module because it has electrical resistance. When the heat sink is very cold, there is not much heat to pump out of the heat sink to send to the occupant side of the system. In addition, the heat pumping capability of the TE module is reduced because the temperature dependent characteristics of the semiconductor material are reduced at low temperatures. Finally, because there is a relatively high difference in temperature between the hot side and the cold side of the TE device, a high Seebeck voltage develops that reduces the effective forward voltage to the TE module.

Other systems using TE devices use separate resistance heating mats in seats to provide much of the heating to heat a seat in the heating mode of the seat heating and cooling system. As previously noted, in the Cauchy U.S. Ser. No. 15/526,954 application “Heating and Cooling Technologies,” many applications can be satisfied by the system without the use of a separate heating mat.

In that regard, since there are many applications for thermoelectric heating systems that include heating units, for example in both the automotive sector for heated seats and the office furniture heated seat segments, along with jackets, pants, gloves and other heated garments for outdoor use, or even for use in hospital beds, among other segments that find good utility with thermoelectric heating systems, a rapidly heating unit would find solid utility.

It would be especially desirable to the heated seat segment of the automotive industry for heated seats if there was provided a thermoelectric heating system that experienced a more rapid heating of the seat, as well as a method of making such a rapidly heating seat, without the need for an additional component of an added resistance heating mat spread across the surface to be heated. It would be further desirable for other features including small inclusion of a heated rod, requiring less expense, and heating time to the desired temperature being achievable in a much shorter time.

### SUMMARY OF THE INVENTION

In accordance with the above-noted desires of the various heated unit industries, the present invention provides various aspects of auxiliary resistance heat assisted heating technologies to provide quick heating and thermoelectric heating systems. Such thermoelectric heating systems include, generally, a thermoelectric device in thermal communication with a heat transfer block and a heat sink.

This heat assist invention may include several aspects, including a first aspect of a small, low cost heating rod or cartridge incorporated directly into either the heat sink or the heat transfer block of the thermoelectric engine and a second aspect utilizing articulated graphene to act as an electrical resistor to transfer rapid heating. This first aspect of a novel auxiliary heat rod addition to the heat sink overcomes many of the aforementioned problems with the prior art because the seat occupant is made more comfortable more quickly in cold environments. For example, when one gets into a car with heated seats, it is desirable to have the seats heat up quickly if it is very cold outside. Prior art heated mats do not heat up quickly enough to provide customer satisfaction.

While the prior art heating mats are a separate system from a thermoelectric system, the present invention incorporates a heating methodology that provides for a thermally united system where the heat transfer systems within the thermoelectric system become the pathways for a purely resistant system. In addition, while in heating mode, the thermoelectric device can still be powered in a manner to heat and comfort a person or occupant. For example, once the cartridge heater is inserted into the heat sink, the heat generated by the heater is then pumped by the thermoelectric device to the heat transfer block. This is then in thermal communication with the graphene or other highly conductive heat transfer medium, which in turn, is connected to a seat occupant or other object possible. Clearly, this type of system would not be possible with the heating mat. If the heat cartridge is located in the alternative location, i.e. the heat transfer block, the thermoelectric module is not pumping heat from the cartridge heated heat sink, as it is putting heat directly into the heat transfer material. The flexible sheeted thermally conductive graphene or other highly conductive material is acting as the heat transfer material that is still working with the thermoelectric device to provide heat the heat transfer block.

By utilizing the present invention, efficiency may be increased from 10 to 85%, which provides much faster heating to the occupant, creating more comfort for a person who is in contact with the heating and cooling system. An additional advantage of the present invention is that a single small, compact, lightweight system can provide both heating and cooling. In heating mode, it appears to be novel and non obvious to heat a source from which to pump heat with the thermoelectric device. The warmer a heat sink is, especially in cold ambient temperatures, the more the thermoelectric device is capable of pumping more heat. This occurs more quickly than the thermoelectric device itself, which is trying to extract heat from a cold heat sink. This system is then especially important in cold ambient temperatures where the temperature dependence of the thermoelectric semiconductor causes it to lose some of its heat pumping effectiveness where there is less heat in a cold heat sink to pump out.

In that regard, a first aspect of the present invention includes certain features including a heat rod or heat cartridge inserted into or in direct thermal communication with the heat sink or the heat transfer block instead of a prior art separate resistance heated mat.

Another aspect of the invention includes the use of a resistive heated articulated graphene sheet or other highly flexible conductive material to be used to transfer rapid heating using itself as a resistive heater or being augmented with the separate resistive heating unit. Using the same graphene to transfer heat for heating and cooling that is used for heat generation saves the seat manufacturer from having to add a heating mat which simplifies the seat assembly structure, and avoids the cost of a separate system.

The invention is particularly useful for applications of the aforementioned heated automotive seats in low temperature situations, along with any other application. For heat only seating applications, sheeted graphene may be used as a resistive heater and also is a widespread heat transfer member instead of a conventional resistance heating mat. By utilizing this material, the seat occupant can be made more comfortable in the cold environment as it provides heat spread across the seat surface, avoiding hot spots in the seat, which also adds to its comfort.

Instead of a conventional heating mat system, where the resistive heating element is either wire, printed circuit, or woven or non-woven conductive fibrous materials, the present invention allows for the entire surface to be the resistive element where, because of the high thermal conductivity inherent in the proposed graphene or other highly flexible conductive material, a comparatively small area requires heating because the highly thermally conductive graphene or other highly flexible conductive material can transfer the heat across the entire surface of the seat.

In an attempt to solve the problem presented by the prior art, one aspect of the present invention embeds a small, low cost heating rod or cartridge into the heat transfer block or heat sink of the thermoelectric engine. In a particular application of automotive seats, utilizing the present invention and by employing this concept, the heating time of the thermoelectric assembly to a desired temperature, is greatly improved. This may be a significant factor in allowing the present system to be employed without the use of an added resistance heating mat spread across the seat providing a competitive advantage, as improved performance and lower costs are achieved.

Although the auxiliary resistive heating concept of the present invention will be described by way of examples hereinbelow for specific aspects having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different aspects and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1 is a top perspective view of a thermoelectric module with an implanted auxiliary resistance heat rod made in accordance with the present invention;

FIG. 2 is a side perspective view of a heat sink with an implanted auxiliary resistance heat rod;

FIG. 3A is a top view of etched or deposited graphene resistance legs;

FIG. 3B is a side elevational view of the graphene resistance legs of FIG.3A;

FIG. 3C is a graphic depiction of an articulated graphene strip used as a resistance heater;

FIG. 4 is a side perspective view of yet another aspect of the graphene resistance heater used in a thermoelectric system;

FIG. 5 is a side perspective view of the thermoelectric system of FIG. 4, further comprising an auxiliary electrical resisting heating element;

FIG. 6A is a side elevational view of a thermoelectric system utilizing a crossover graphene system in accordance with the present invention;

FIG. 6B is a bottom perspective view illustrating the relative location of a heat sink;

FIG. 7 is a front elevational view of an automotive seat back incorporating heat distributors of articulated graphene sheets made in accordance with the present invention;

FIG. 8 is a graph of the heat performance when comparing the resistance heat assisted heating and cooling technology made in accordance with the present invention and the unassisted cushion;

FIG. 9 is a top plan view of a seat assembly with the conductor strips shown in place; and

FIG. 10 illustrates yet another aspect of the present invention showing a serpentine configuration of a graphene heat assist over the conductive strips shown in FIG. 9.

### DETAILED DESCRIPTION OF THE INVENTION

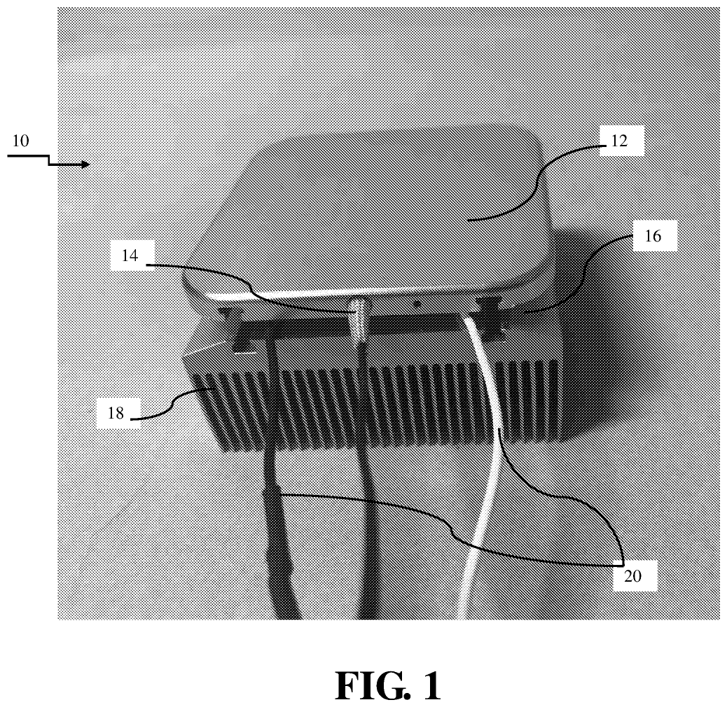

Referring now to the drawings in detail, FIG. 1 illustrates a portion of a thermoelectric assembly, especially a resistive sheeted thermoelectric assembly, generally denoted by the numeral 10, and including a view of an auxiliary heat rod 14 inserted into and in thermal communication with a heat transfer block 12. Thermoelectric module 16 is sandwiched between heat transfer block 12 and heat sink 18, and is the source of heating for this thermoelectric assembly 10. Thermoelectric module wires 20 are in electrical communication with thermoelectric module 16. By inserting heater cartridge 14 into heat transfer block 12, rapid heating is achievable, as the heating element of the thermoelectric device can be more quickly dedicated to generating heat to comfort a person, more rapidly than if the thermoelectric device was generating heat to increase its operational capabilities.

Useful materials for the heat rod or heat cartridge include steel, stainless steel, aluminum, brass Inconel, Incoloy, or any other suitable material. Although one of the most preferred heat rod units have 4.8 ohms resistance, depending on the heating power required, this can vary considerably. The same heater cartridge provides 30 W of heat energy at 12 V DC. Certain applications may require higher power units for faster system heat up or lower power units for those systems that do not require the heat up speed or total watts that are provided for heating.

In this first aspect of the invention, the preferred heater rod may be from 20 mm up to 200 mm in length. Preferred units are approximately from 2.0 mm to 10 mm in diameter and about 50 mm long. Depending on the requirements of the particular application, this can vary from even smaller diameters to much greater diameters, depending on the application. Preferred relative placement of the heater rod may be either on the heatsink or on the heat transfer block on the thermoelectric hot side. Certainly, virtually anywhere on the heatsink or heat transfer block may provide benefit. Given the thickness of the metal of the heatsink, the cartridge heater may be placed virtually anywhere in the cross-section. Heater rods or heat cartridges useful for the present invention may be able to reach temperatures of 760° C., although for this application, the present invention only uses them up to approximately 125° C.

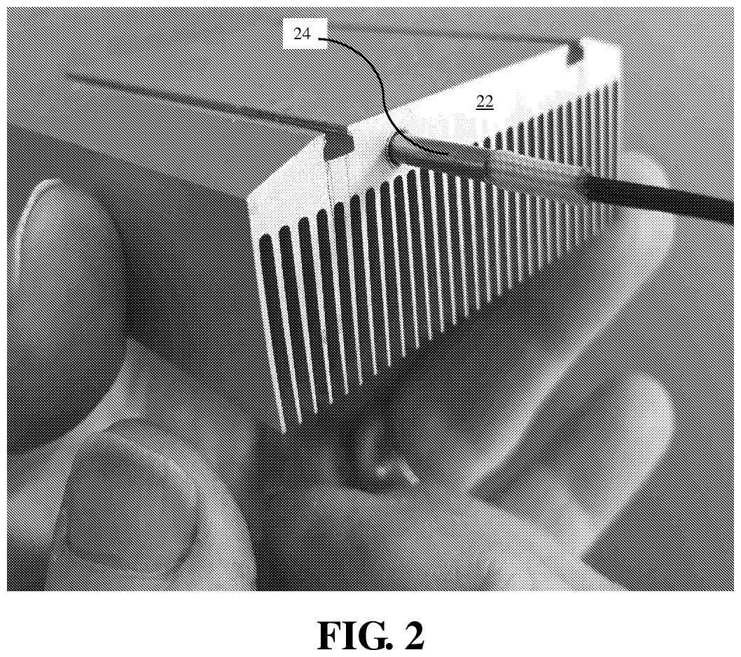

Looking next FIG. 2, there is shown another aspect of the present invention wherein a heating cartridge 24 is inserted into the body of heat sink 22. In this application, all the heat from the thermoelectric device would then be available to comfort a person in contact with the heat transfer block and its overlying layers.

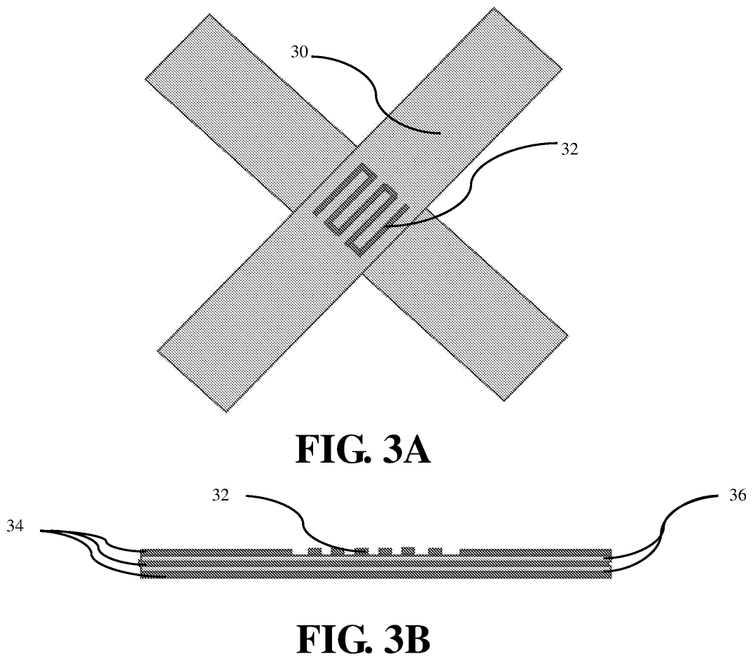

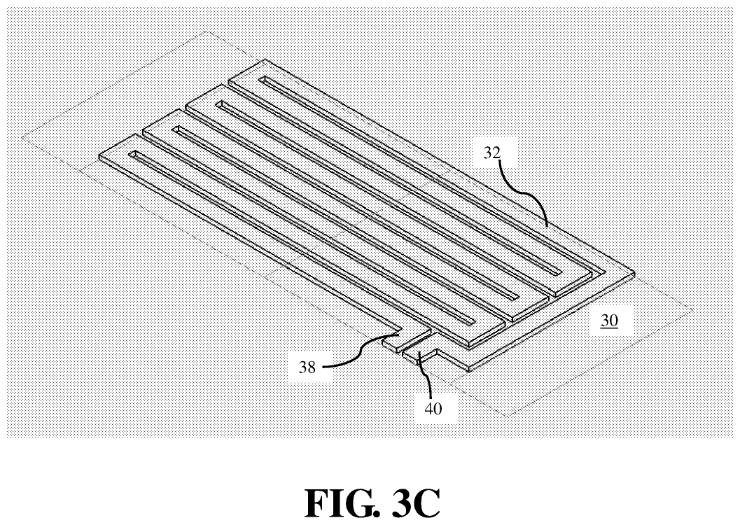

FIGS. 3A, 3B and 3C collectively represent yet another aspect of the present invention wherein etched or deposited graphene resistance legs are utilized as articulated resistance heaters. Graphene sheets 30 have either been etched into or deposited thereon graphene resistance legs 32, wherein the graphene becomes the resistance heater itself. For the sake of brevity, we will refer to graphene, although it must be realized that any suitable sheeted flexible highly thermally conductive material, such as copper and/or its alloys, aluminum, etc., could be employed and are within the scope of the present invention. Depending upon the application, preferable materials will be selected. Non-moving applications can use materials that do not bend or stretch, while car or office seats would likely need a more robust material. Due to the pattern created, the graphene builds up resistance because, like thin wires, low voltages create resistance. In the present aspect, FIG. 3C shows a single layer of graphene that is articulated and laminated between plastic film layers. Graphene strips, or any other suitable shape, may be fabricated so that the graphene is in a serpentine or other pattern to become an electrical resistive heater.

In the thermoelectric heating and cooling system of the present invention, the same graphene strip conducts heat being pumped either into or out of the strip by the thermoelectric device. It is a cooling conduit, a heating conduit, and a resistive heater. Encapsulation in the flexible plastic fill allows the articulated graphene strip to be electrically isolated, but thermally conductive.

Unlike other type resistive heaters, disclosed in prior art patents or other applications, the entire surface heats up by utilizing the articulated graphene strip as a resistance heater. Meanwhile, heaters have to be brought to a high temperature, given their small diameter. However, because the entire surface of this multipurpose graphene strip is heated, lower temperatures can be used to put heat into a person or object for personal comfort. Both DC and AC electrical current can be used to run the heater portion of the system, as the thermoelectric system operates in DC current. In this particular aspect, the articulated graphene strip is electrically series, while formally in parallel.

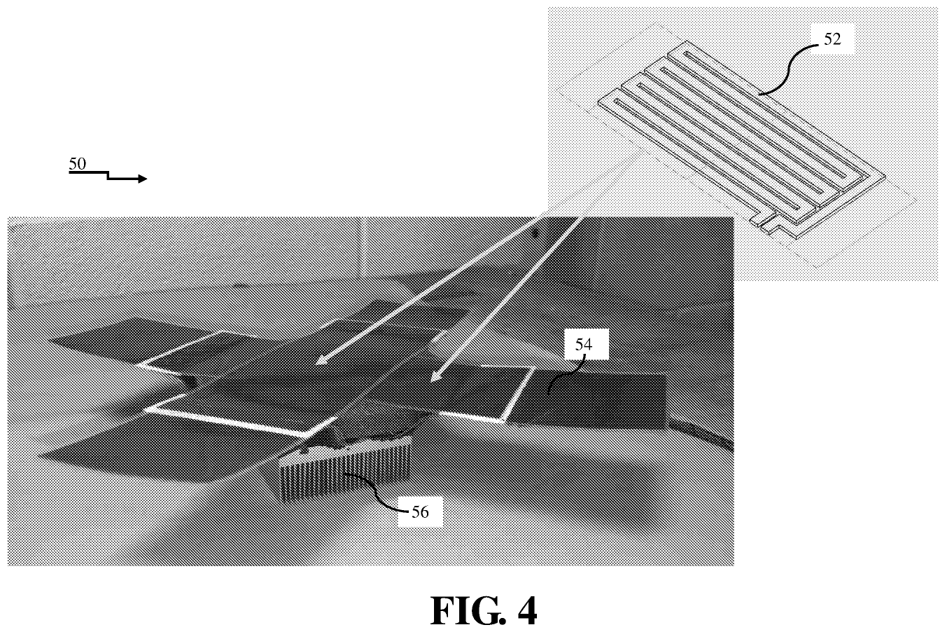

FIG. 4 shows another aspect of the present invention utilizing the articulated graphene strips as a cooling and heating conductor and resistance heater used in a heated thermoelectric system. The thermoelectric heating and cooling system is generally denoted by numeral 50, and includes articulated graphene strips 52. The graphene or other highly conductive material is the heat transfer and resistive heating element that becomes part of the heating and cooling system. The serpentine pattern of the articulated graphene strips need long legs in order to get the resistance. Graphene sheets 54 are located on top of heat sink 56 and act as a resistance heater in order to achieve more rapid heating of the system.

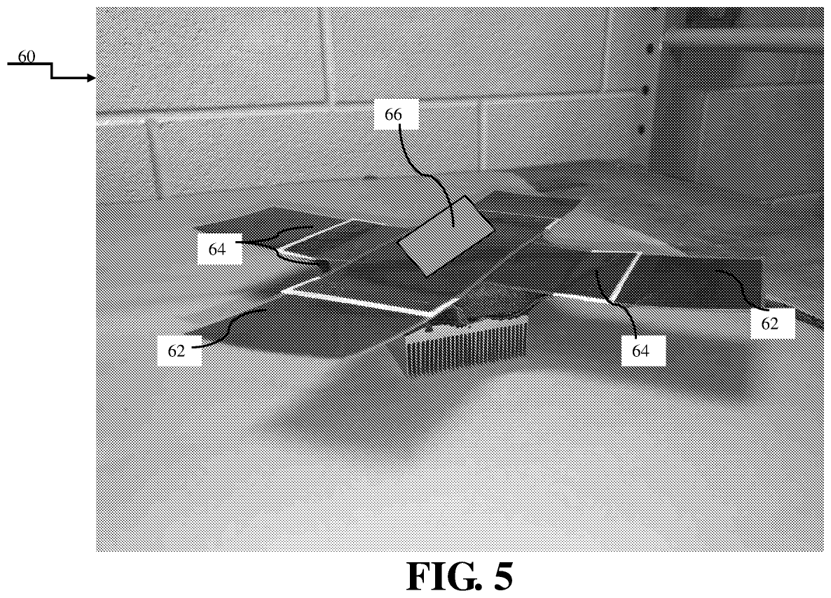

FIG. 5 shows a similar aspect of FIG. 4, although in this thermoelectric assembly, generally denoted by numeral 60, the graphene sheets 62 are in direct thermal communication with the thermally conductive plastic film which encapsulates the articulated graphene strips 64. An additional heating element 66, which may be a conventional electrical resistance heater, may also be incorporated in this aspect. As noted before, other suitable resistant heater materials may be preferred.

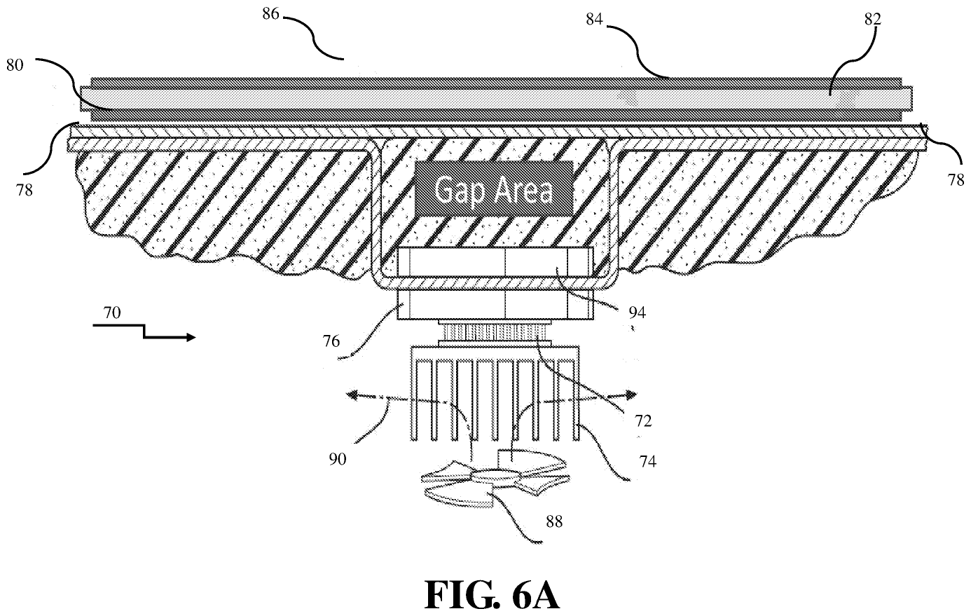

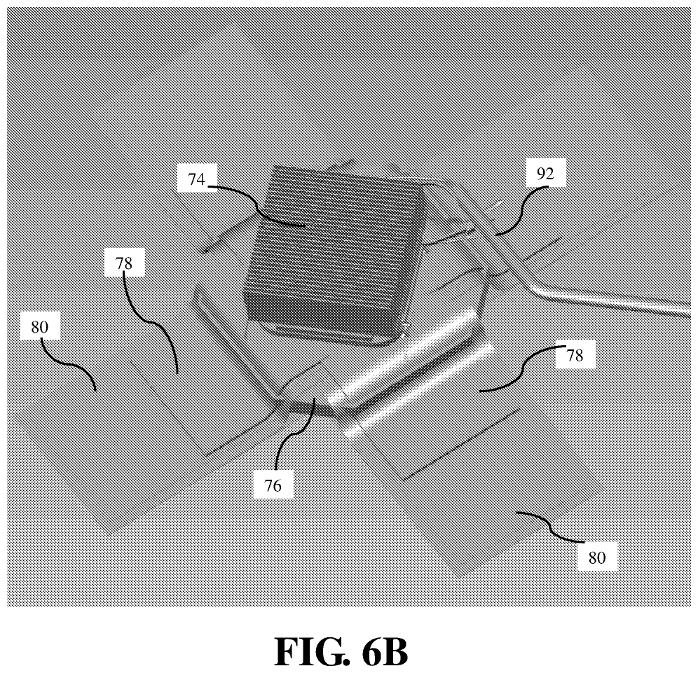

FIG. 6A illustrates yet another aspect of the present invention, including a crossover graphene sheet 80, and is generally denoted by numeral 70, which includes a thermoelectric element module 72 in thermal communication with the heat sink 74 and lower heat transfer block 76. A graphene depth extender wings 78 is located between lower heat transfer block 76 and upper heat transfer block 94, thereby creating a gap area underneath the crossover graphene 80, or alternatively any other flexible highly conductive thermal material 80. A resistance heater 82 is directly on top of crossover graphene sheet 80, and underneath foam layer 84 and cover 86. In this aspect, an automotive seat is consequently heated, and may use conductive or non-conductive foam layer 84 and either a cloth cover 86 or a perforated leather or vinyl cover 86.

Looking next to FIG. 6B, the thermoelectric assembly of FIG. 6A is illustrated in a bottom perspective view, showing the relative placement of heat sink 74, lower heat transfer block 76, graphene depth extender wings 78, crossover graphene 80 and thermoelectric module wires 92.

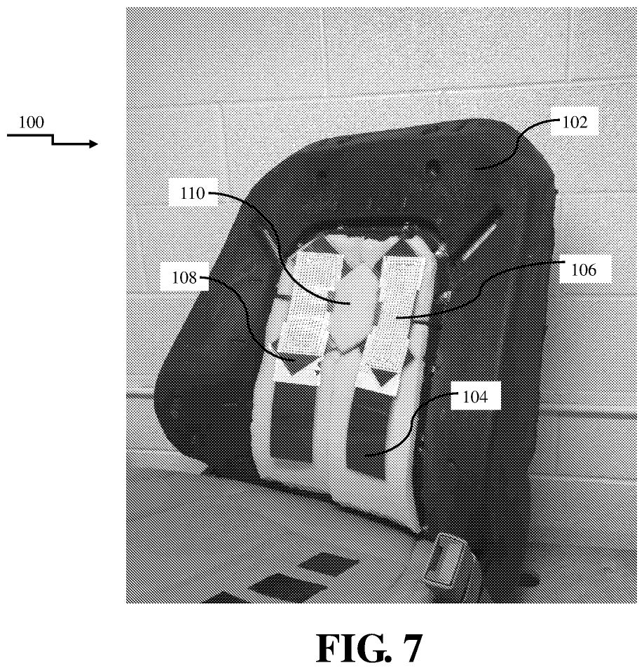

Looking now to FIG. 7, the present graphene resistance heating concept is illustrated installed in an automotive seat back 100. Automotive seat back 100 includes a seat back foam portion 102 having graphene extender sheets 104 to provide heat throughout the back of the seat back assembly 100. Graphene, or other highly conductive material, presented as an articulated resistance sheet 106, is shown in thermal communication with crossover graphene layer 108. Referring back to FIG. 6A, one can see the gap area, and then referring forward to FIG. 7, one can see a corresponding unheated gap area 110, as heat is not needed in that portion.

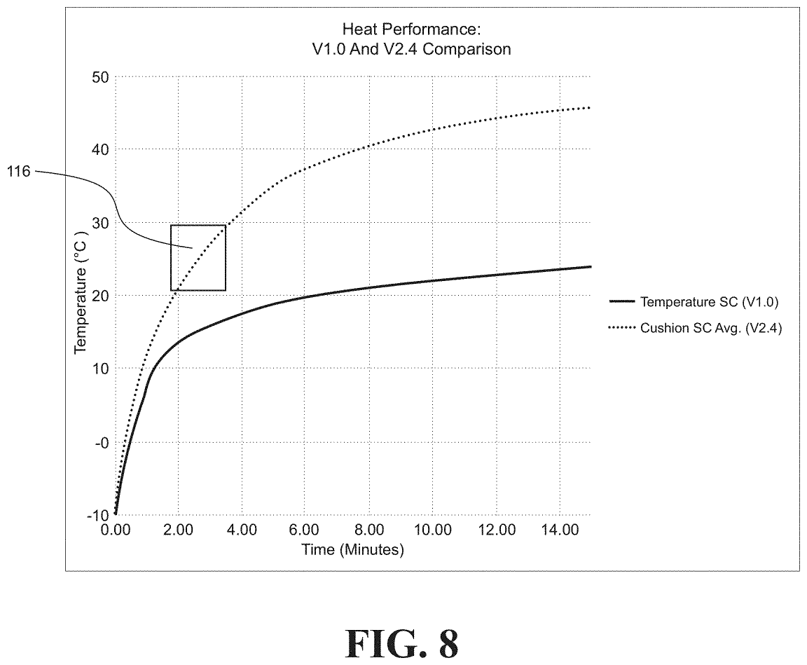

FIG. 8 is a graph charting the rise in temperature versus time in minutes to illustrate the heat performance between an unassisted question and the resistance heat assist in accordance with the present invention. As one can see from this graph, the rate of heating up is greatly increased, and the ultimately achieved temperature is nearly twice as high. The unassisted first version reaches a high temperature of 25° C., whereas the ultimately achieved temperature utilizing the resistance heat assisted technology the present invention was a bit greater than 45° C. Further, achieving a heated seat temperature of 25° C., which is the ultimate temperature of the unassisted cushion, occurs much faster, i.e. in 2 min. versus 14 min. for the unassisted cushion. Clearly, this provides an advantage over the prior art because it is more desirable for a quicker heating response. A faster time-to-sensation is important as the industry wants to quickly provide nearly instant heated and/or cooled comfort for an occupant. Of course, this resistance heat assisted cooling and heating technology is in accordance with the present invention and is applicable to all personal thermal comfort applications. Looking back at the graph, the box 116 indicates the range of heating response that is acceptable within the automotive industry. While other industries may find longer heating response times to be acceptable, the standard for such heating response times for the automotive industry may rule.

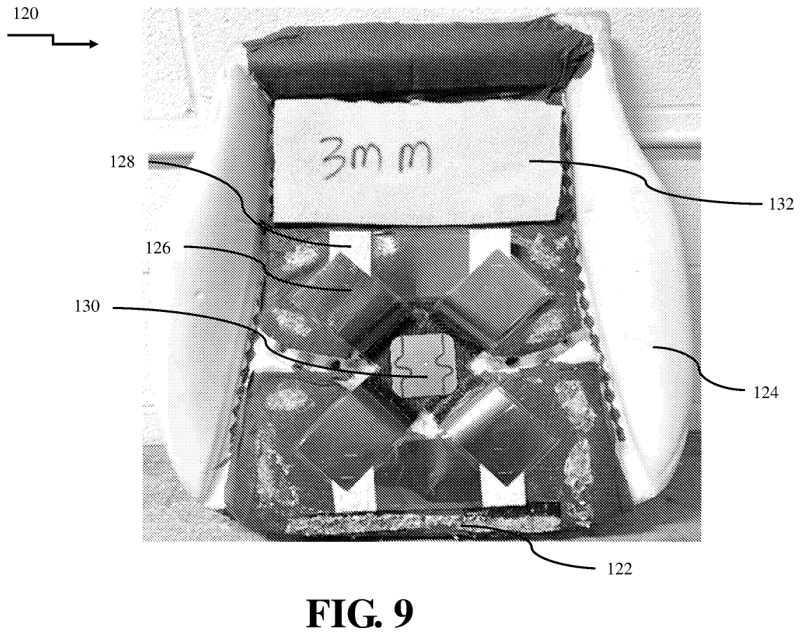

FIG. 9 illustrates yet another aspect of the present invention. While the previous aspect illustrates a direct thermal connection between the resistance heating device to the thermally conductive materials, providing heat directly to the seat occupant as well as being further distributed by the graphene or other thermally conductive material of the heating and cooling technology system, this aspect of a resistance heat assisted device is much larger and does not require direct thermal vacation with the thermally conductive material. The previous aspect may be considered of “dual use”, as it provides both heating and cooling. This aspect may be placed over the heating and cooling technology system. In this aspect, the resistive heat assist material may be incorporated or deposited onto a layer of compressible foam. The compressible foam would place the resistance heating device under a seat cover or a seat cover assembly that may also incorporate a thin layer of foam as part of its construction.

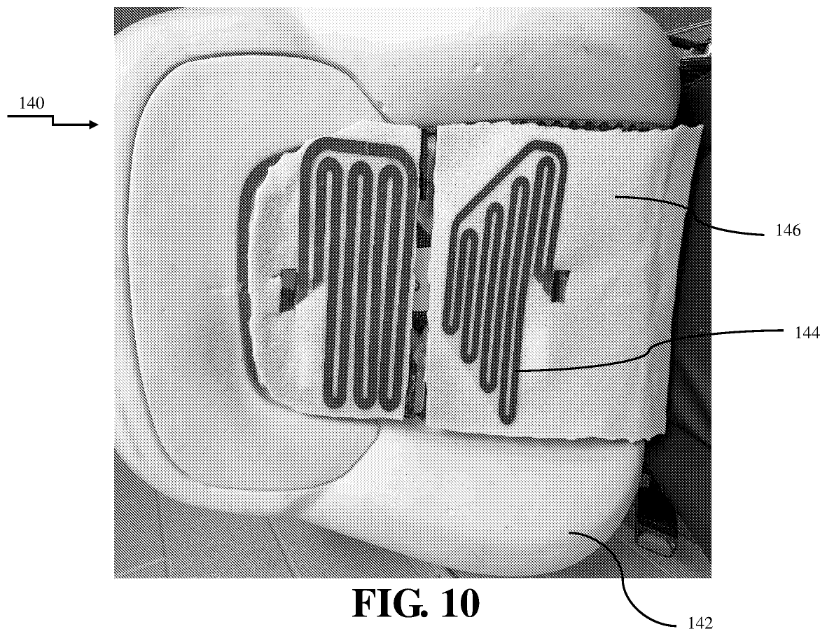

Referring still to FIG. 9, this new aspect is generally denoted by numeral 120, including seating material 122 as part of seat 124. A thermally conductive backing strip 128 provides support for thermally conductive material strips 126, preferably graphene or a like thermally conductive material, which are, in turn, in thermal communication with the thermal engine 130. A partially peeled back foam layer 132 has been peeled back to reveal the heating and cooling technology system of the present centered around the thermal engine 130. Upcoming FIG. 10 illustrates this aspect better with the foam having a resistive heat assist system Incorporated therein folded out, where it can be seen that the resistive heat assist foam and resistive heat assist resisters may preferably be directly underneath a seat cover in order to speed up heating for comfort of the occupant.

FIG. 10 illustrates another aspect of the present invention with a variation of a resistance heater 144 made of graphene, but of a much larger surface area than previous aspects, thereby providing very rapid heating of the seat occupant. Such a seat assembly is denoted generally by numeral 140, including seat 142 at least partially covered by a foam layer 146, preferably of a viscoelastic foam, having a graphene resistive heater 144 in thermal communication with the foam 146. This variation is a resistance heater made from graphene, providing a much larger surface area coverage that does not require direct thermal communication with the graphene thermally conductive material strips 126 of FIG. 9. This aspect of the invention provides an option for either direct thermal communication with the heating and cooling technology system aspect previously described herein, or it may be placed over the heating and cooling technology system with a layer of compressible foam, which places the resistance heating element under the seat cover or seat cover assembly that may also have a thin layer of foam or scrim as part of its construction.

When the resistance heater 144 is powered, it heats the seat occupant rapidly and evenly due to its high surface area coverage. And when the layer of foam 146 is crushed by the weight of the seat occupant, the graphene or other thermally and electrically conductive material seat resistance heater 144 comes into thermal communication with the heating and cooling technology system graphene, heat is further spread over a larger surface area.

In this aspect, the type of foam that works best is one that can be compressed to a small thickness upon occupant sitting in the seat. While any suitable foam may be used, the preferred foam is a relatively dense viscoelastic foam, such as that made by Bergad of Kittanning, Pa. USA. It should be pointed out, that the resistance heater and phone combination can also be placed directly upon the graphene of the heating and cooling technology system. In this particular instance, the thickness of the graphene used was 40 μm although the thickness may be from 10 μm to 1000 μm. From subjective testing, it appears to be superior in performance to the other aspects. In some cases, seat occupants noted first sensation of heating in under 30 seconds.

Another feature that drops out of the technology because of its large format, highly conductive nature is that the maximum temperature required from the resistance heater 144 itself is close to the normal upper temperature limits set by seating companies to avoid overheating or even burning a seat occupant. A normal temperature upper limit not to be exceeded on the seat surface is from 40° C. to 45° C., commonly 43° C. It should also be noted that because there is more graphene area coverage on a seat, cooling is also distributed by resistance heater 144, even though the resistance heater 144 is obviously not powered in cooling mode. By utilizing graphene as the material for the resistance heater 144, rather than using only materials suitable for heating, cooling effect may also be rapidly distributed to the seat occupant.

Therefore, in accordance with the present invention, a heat resistant heat and cool assist device for providing heat and cool comfort to a person may include at least one heat resistant graphene thermal conductor covering a surface area of a heat and cool device for thermal communication to comfort a person, wherein the heat resistant graphene thermal conductor has a time-to-sensation time period of from 5 seconds to 10 min. and is capable of reaching temperatures from 5° C. to 60° C. for providing heat and cool comfort to a person.

The heat resistant graphene thermal conductor is selected from the group consisting of sheets, strips, woven strips, serpentine configured conductors, vapor deposited patterns on a substrate, etched patterns on a substrate, and combinations thereof, depending on the most efficacious configuration.

Especially effective is a configuration wherein the heat resistant graphene thermal conductors are adhered to a foam substrate, whether adhesively affixed, woven into the foam substrate, sprayed onto the foam substrate, vapor deposited onto the foam substrate or affixed thereon. This foam/graphene thermal conductor combination is especially useful in padded seats, such as in automotive seating and office furniture. The heat resistant graphene thermal conductor is preferably flexible for comfort and durability. As the heat resistant graphene thermal conductor is electrically connected to a power source, it provides a boost to the thermoelectric device in speeding up the time-to-sensation for anyone sitting in a seat assembly made in accordance with the present invention. While the heat resistant graphene thermal conductor is in thermal communication with a thermal engine, the thermal engine may be slower to heat up an entire assembly, so the present invention can provide a desired boost.

Further, the heat resistant graphene thermal conductor may either be in direct or in indirect thermal communication with the thermal engine heat and cool assembly. Direct communication with the heat transfer block of one of the above described aspects may prove to be sufficient. On the other hand, in direct thermal communication may be more effective, since it is in more direct contact with the person being comforted, as well as it may cover a larger area of the seat, covering a surface area that covers more of the seating area touching the person. As such, the heat resistant graphene thermal conductor may be laid on top of the heat and cool device that includes a thermoelectric device thermal engine having flexible thermally conductive material being thermally connected thereto. The heat resistant graphene thermal conductor is contemplated to be part of an entire seat assembly, and where it is located under a seat cover of the seat assembly.

Another aspect of the heat resistant heat and cool assist device for providing heat and cool comfort to a person includes a number of components including a thermoelectric module thermal engine, some conductive thermal material in thermal communication with the thermoelectric thermal engine, a heat sink thermally connected to the thermoelectric thermal engine, a heat transfer block in thermal communication with the thermoelectric thermal engine and at least one heat resistant graphene thermal conductor covering a surface area of the heat and cool device for thermal communication to comfort a person. In this aspect, the heat resistant graphene thermal conductor may have a time-to-sensation time period of from 5 seconds to 10 min. that is capable of reaching heat and cool temperatures from 5° C. to 60° C. for providing heat and cool comfort to the person.

In many instances, a preferred configuration includes a thermoelectric module thermal engine sandwiched between the heat sink and the heat transfer block. Further in this aspect, suitable conductive thermal materials in thermal communication with the thermoelectric thermal engine include graphene, graphite, aluminum, copper, and other highly conductive flexible materials.

For indirect thermal communication, the heat resistant heat and cool assist device would preferably be electrically connected to a power source to generate heat and cool so that it is capable of indirectly thermally communicating with the thermal engine.

Yet another aspect of the present heat resistant heat and cool assist device for providing heat and cool comfort to a person includes an auxiliary heating rod or cartridge incorporated directly into either the heat sink or the heat transfer block of the thermoelectric engine to increase the time period for time-to-sensation to comfort a person. This auxiliary heat rod is preferably in combination with a thermoelectric module thermal engine, the conductive thermal material in thermal communication with the thermoelectric thermal engine, along with a heat sink as described hereinabove being thermally connected to the thermoelectric thermal engine, as well as a heat transfer block in thermal communication with the thermoelectric thermal engine.

The heat rod or heat cartridge is made of suitable materials including steel, stainless steel, aluminum, brass Inconel, Incoloy, or any other suitable material. Upon selecting these materials, it is preferable that the heat rod or heat cartridge has an electrical resistance of from 2 ohms to 20 ohms, preferably 4.8 ohms, capable of providing from 5 W to 50 W of heat energy at 12 V DC.

The foregoing description of various preferred aspects of the invention has been presented for purposes of illustration and description. It is not intended to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated. It is intended that the scope of the invention be defined by the claims which are appended hereto.

Although the present invention has been described mostly in the context of a car of office seat, the invention is not to be so limited. The present invention also finds utility for all automotive surfaces that contact a person or occupant, such as armrests, consoles, steering wheels, or any other interior surfaces. Further, it is envisioned that this technology can be used on garments. gloves. boots, shoes. head gear, coats, etc. to quickly heat up the wearer. All the applications listed in U.S. Ser. No. 15/526,954 would also find utility for the present invention.

In summary, numerous benefits have been described which result from employing any or all of the concepts and the features of the various specific aspects of the present invention, or those that are within the scope of the invention.

### INDUSTRIAL APPLICABILITY

The present invention finds utility in various seating applications, such as those in the automotive, motorcycle, boat and being applications, office furniture, military vehicle, agricultural equipment, and other related industries, in addition to hospital equipment, garment, and other non-seating application industries.

1-18. (canceled)

19. A thermoelectric heating system with resistance heater graphene, the thermoelectric heating system comprising:
a thermoelectric device comprising a first side and second side, the thermoelectric device configured to pump heat;
a heat transfer block thermally connected to the first side of the thermoelectric device;
a heat sink thermally connected to the second side of the thermoelectric device;
a conductive thermal material thermally connected to the heat transfer block, the conductive thermal material configured to distribute heat pumped by the thermoelectric device over a surface area configured to contact a person; and
a resistance heat graphene thermal conductor positioned across the surface area configured to contact the person, the resistance heat graphene thermal conductor configured to receive electrical power to generate heat.

20. The thermoelectric heating system of claim 19, wherein the resistance heat graphene thermal conductor comprises at least one of sheets, strips, serpentine configured conductors, vapor deposited patterns on a substrate, or etched patterns on the substrate.

21. The thermoelectric heating system of claim 19, wherein the conductive thermal material comprises at least one of graphene, graphite, aluminum, copper, or highly conductive flexible materials.

22. The thermoelectric heating system of claim 19, wherein the resistance heat graphene thermal conductor is incorporated or deposited onto a layer of compressible foam of an automotive seat, the automotive seat comprising the surface area configured to contact the person.

23. The thermoelectric heating system of claim 22, wherein the resistance heat graphene thermal conductor is incorporated or deposited onto the layer of compressible foam of the automotive seat in a serpentine pattern.

24. The thermoelectric heating system of claim 19, wherein the heat transfer block comprises a lower heat transfer block and an upper heat transfer block, and wherein the conductive thermal material comprises extender wings located between the lower and upper heat transfer blocks.

25. The thermoelectric heating system of claim 24, further comprising a crossover sheet in thermal communication with the extender wings to distribute heat pumped by the thermoelectric device in portions of the surface area over the thermoelectric device.

26. The thermoelectric heating system of claim 19, further comprising a crossover sheet in thermal communication with the conductive thermal material to distribute heat pumped by the thermoelectric device in portions of the surface area over the thermoelectric device.

27. The thermoelectric heating system of claim 19, further comprising a crossover sheet in thermal communication with the resistance heat graphene thermal conductor.

28. The thermoelectric heating system of claim 19, wherein the resistance heat graphene thermal conductor is etched or deposited onto the conductive thermal material.

29. The thermoelectric heating system of claim 28, wherein the resistance heat graphene thermal conductor is etched or deposited onto the conductive thermal material in a serpentine pattern.

30. The thermoelectric heating system of claim 19, wherein the resistance heat graphene thermal conductor is in thermal communication with the conductive thermal material, wherein the resistance heat graphene thermal conductor is configured to distribute heat pumped by the thermoelectric device.

31. The thermoelectric heating system of claim 30, wherein the resistance heat graphene thermal conductor is in direct thermal connection with the conductive thermal material.

32. The thermoelectric heating system of claim 19, wherein the resistance heat graphene thermal conductor is in thermal communication with the thermoelectric device.

33. The thermoelectric heating system of claim 32, wherein the resistance heat graphene thermal conductor is in direct thermal communication with the thermoelectric device.

34. The thermoelectric heating system of claim 33, wherein the resistance heat graphene thermal conductor is in direct thermal communication with the thermoelectric device via the heat transfer block.

35. The thermoelectric heating system of claim 19, further comprising an electrical resistance heater across the surface area, the electrical resistance heater configured to receive electrical power to generate heat.

36. The thermoelectric heating system of claim 35, wherein the electrical resistance heater is in thermal communication with the resistance heat graphene thermal conductor.

37. A thermoelectric heating system with resistance heater, the thermoelectric heating system comprising:
a thermoelectric device comprising a first side and second side, the thermoelectric device configured to pump heat;
a heat sink thermally connected to the second side of the thermoelectric device;
a conductive thermal material thermally connected to the first side of thermoelectric device, the conductive thermal material configured to distribute heat pumped by the thermoelectric device over a surface area configured to contact a person; and
a resistance heat thermal conductor positioned across the surface area configured to contact the person, the resistance heat thermal conductor configured to receive electrical power to generate heat.

38. The thermoelectric heating system of claim 37, wherein the resistance heat thermal conductor comprises graphene.

39. A thermoelectric heating system with a heating cartridge, the thermoelectric heating system comprising:
a thermoelectric device comprising a first side and second side, the thermoelectric device configured to pump heat;
a heat transfer block thermally connected to the first side of the thermoelectric device;
a heat sink thermally connected to the second side of the thermoelectric device;
a conductive thermal material thermally connected to the heat transfer block, the conductive thermal material configured to distribute heat pumped by the thermoelectric device over a surface area configured to contact a person; and
a heating cartridge in thermal communication with the heat sink or the heat transfer block, the heating cartridge configured to receive electrical power to generate heat.

40. The thermoelectric heating system of claim 39, wherein the heating cartridge comprises a heating rod.

41. The thermoelectric heating system of claim 39, wherein the heating cartridge is in thermal communication with the heat sink.

42. The thermoelectric heating system of claim 41, wherein the heating cartridge is inserted into the heat sink.

43. The thermoelectric heating system of claim 39, wherein the heating cartridge is in thermal communication with the heat transfer block.

44. The thermoelectric heating system of claim 43, wherein the heating cartridge is inserted into the heat transfer block.
